(19) United States
(12) Patent Application Publication
(10) Pub. No.: US 2024/0391765 A1
(43) Pub. Date: Nov. 28, 2024

(54) USE OF CARBONACEOUS CARRIER MATERIAL IN BED REACTORS

(71) Applicant: BASF SE, Ludwigshafen am Rhein (DE)

(72) Inventors: Grigorios KOLIOS, Ludwigshafen am Rhein (DE); Andreas BODE, Mannheim (DE); Johannes BODE, Ludwigshafen am Rhein (DE); Laila Raquel PASIN E MATOS, Ludwigshafen am Rhein (DE); Michael REITZ, Ludwigshafen am Rhein (DE); Frederik SCHEIFF, Ludwigshafen am Rhein (DE); David SCHLERETH, Ludwigshafen am Rhein (DE)

(21) Appl. No.: 18/698,377

(22) PCT Filed: Sep. 26, 2022
(86) PCT No.: PCT/EP2022/076617

§ 371 Date: Apr. 4, 2024

(30) Foreign Application Priority Data
Oct. 6, 2021 (EP) 21201162.1

(51) Int. Cl. C01B 3/26; B01J 8/02

(52) U.S. Cl. CPC C01B 3/26; B01J 8/0292; B01J 2208/024; C01B 2203/0233; C01B 2203/1011; C01B 2203/1241

(57) ABSTRACT

The present invention provides a process of producing hydrogen comprising introducing methane and/or other light hydrocarbons into a reaction chamber and reacting said gases in said reaction chamber in a bed of solid carbonaceous materials to give hydrogen, wherein said carbonaceous materials are macro-structured carbonaceous materials, wherein the porosity of the carbonaceous material is in the range of 30 to 70 vol.-% and the carbonaceous material contains a content of carbon of 99 wt.-% to 100 wt.-% and a content of alkaline-earth metals, transition metals and metalloids of 0 and 1 wt.-% in relation to the total mass of the solid carbonaceous material, wherein the iron content is between 0 and 0.5 wt.-%, the magnesium content is between 0 and 0.005 wt.-%, the manganese content is between 0 and 0.01 wt.-%, the silicon content is between 0 and 0.01 wt.-% and the nickel content is between 0 and 0.025 wt.-%. In addition, the present invention provides the use of said carbonaceous materials as carrier material in bed reactors.

The present invention provides a process of producing hydrogen comprising introducing methane and/or other light hydrocarbons into a reaction chamber and reacting/decomposing said gases in said reaction chamber in a bed of solid carbonaceous materials to give hydrogen, wherein said carbonaceous materials are macro-structured carbonaceous materials, wherein the porosity of the carbonaceous material is in the range of 30 to 70 vol.-% and the carbonaceous material contains a carbon content of 99 wt.-% to 100 wt.-% and a content of alkaline-earth metals, transition metals and metalloids of 0 and 1 wt.-% in relation to the total mass of solid carbonaceous material, wherein the iron content is between 0 and 0.5 wt.-%, the magnesium content is between 0 and 0.005 wt.-%, the manganese content is between 0 and 0.01 wt.-%, the silicon content is between 0 and 0.01 wt.-% and the nickel content is between 0 and 0.025 wt.-%.

In addition, the present invention provides the use of said carbonaceous materials as carrier material in bed reactors.

### STATE OF THE ART

DD 118263 discloses a process for producing solid carbon by pyrolysis of gaseous hydrocarbons in a moving bed reactor. Carbon particles are used as carrier material and these particles are guided as a moving bed countercurrent to the gaseous hydrocarbon flowing upwards. Due to the pyrolysis solid carbon deposits on the carrier material, is cooled by direct heat exchange with the gaseous hydrocarbons and is drawn off via a lock. Part of these carrier material is recycled after a crushing step to keep the carrier material particle distribution constant. No further details are given in view of the used carrier material, e. g. particle distribution, pore volume, pore size distribution or BET surface.

Goehler et al. discloses in “Mitteilungen des Brennstoffinstitutes Freiberg 5 (1974) 1” a similar moving bed reactor, mentioning that the carrier material particle size is between 1 and 3.15 mm. The flow velocity of the gaseous hydrocarbons was 2 to 40 l/h and the moving bed velocity was 30 to 50 g/h avoiding carbon material deposition on the wall of the reactor. As a carrier material calcined brown coal tar coke, electrographite and anthracite was used, but the example showed that the influence of the specific carbon particle used was relatively small. No further details are given in view of the used carrier material, e. g. particle distribution, pore volume, pore size distribution or BET surface.

CH 409890 and U.S. Pat. No. 2,982,622 discloses a process of converting hydrocarbon in a high temperature conversion into light products and high-grade coke by contact with electrically heated, dense mass of solid particles. Preferred carrier materials are coke or coal. In some operations two types of particles may be employed. The solids are maintained in the form of a dense, moving bed having a density in the range of 40 to 75, e. g. 64 lbs./ft (0.641 to 1.20, e.g. 1.026 g/cm³). The coke generally ranges from about 0.05 to 1.0 inch (0.127 to 2.54 cm) in size, the bulk of the solids being approximately 0.25 of an inch (0.635 cm) in diameter. The solids are introduced into the upper part of the reactor and are fed at a speed of 2.75 to 3.0 m/hour in the form of a moving or fluidized bed maintained by gravity. The pore volume fraction, calculated by the particle density of

$$\\ 110 lbs / {ft}^{3} ( {ρ}_{p} = 1762 \frac{kg}{{m}^{3}} )$$

and the density of carbon

$$\\ {ρ}_{C} = 2200 \frac{kg}{{m}^{3}} via {ρ}_{p} : {ε}_{p} = 1 - \frac{{ρ}_{p}}{{ρ}_{C}} ,$$

is about 20%. The disadvantage of this concept is the limited carbon deposition per bed volume: due to the low pore volume fraction of 20%, carbon deposited on the geometric surface of the particles will lead to agglomeration of the bed.

U.S. Pat. No. 5,486,216 discloses a batchwise method of upgrading of low-grade coke by forming a small carbon coating on the pores of the coke by hydrocarbon cracking in a fixed bed by temperature of 700° C. to 1100° C. to improve the strength of the coke and reduce its oxidation by CO2. The deposition of carbon closes the entrance of the small pores having a pore radius between 30 nm and 0.3 μm. The pore volume, calculated by the specific pore volume analog FIG. 5a

$$\\ ( {v}_{p} = 3 \cdot {10}^{{}_{} - 7} \frac{{m}^{3}}{g} ) via {v}_{p} : {ε}_{p} = \frac{1}{1 + \frac{1}{{v}_{p} \cdot {ρ}_{C}}} ,$$

is above 35.5%. The median pore size shown in FIG. 5a is about 20 to 40 μm. The disadvantage of this concept is the formation of carbon black. In addition, the impurities like manganese, magnesium, iron and/or ash forming components as present in low-grade coke might resolve, deposit on the reactor walls and block the reactor. These issues are even more severe, if the process is not run in a batchwise mode in order to upgrade coke as given in U.S. Pat. No. 5,486,216, but if the process is run continuously and at harsher pyrolysis conditions (in particular at temperatures >1373 K). The latter is particularly preferred, if high carbon deposition rates are desired for producing hydrogen instead of upgrading properties of the coke by mild reaction conditions as in U.S. Pat. No. 5,486,216.

US 2002/7594 discloses a process for sustainable CO2-free production of hydrogen and carbon by thermocatalytic decomposition of hydrocarbon fuels over carbon-based catalysts in the absence of air and/or water. Preferably the process is conducted continuously by using a moving or fluidized bed of carbon particles. Product-carbon is withdrawn from the bottom of the bed and partly ground into fines and recycled. In the examples activated carbon, carbon black and graphite are used; e.g. activated carbon particles with a surface area of 1,500 m2/g, a total pore volume of 1.8 ml/g (εₚ 79.8%) and particle size of 150 μm, carbon black particles with a surface area of 1,500 m2/g and a particle size of 0.012 μm and graphite particles with a surface area of 10 to 12 m2/g and a particle size of 50 μm were used.

The average pore radius can be calculated by rₚ=2 Vₚ/aₘ to be about 2.5 nm

$$\\ ( {a}_{m} = 1500 \frac{{m}^{2}}{g} , {ρ}_{C} = 2200 \frac{kg}{{m}^{3}} , {ε}_{p} = 79.8 \% ) {}_{} .$$

The disadvantage of the small average pore radius is that the associated pore volume is not accessible for carbon deposition since the pore entrances are blocked by carbon deposition. This is disclosed in U.S. Pat. No. 5,486,216. Thus, after blockage of the pore entrances, carbon will be deposited on the geometric surface of the particles leading to agglomeration of the particle bed. In addition, the high pore volume of 79.8% reduces the mechanical stability of the particles, which can lead to breakage or attrition of the particles in fixed-, moving- or fluidized-bed operation in industrial dimension.

Like US 2002/7594, WO 2009/95513 describes the production of hydrogen by catalytic decomposition of methane and other light hydrocarbons at temperatures between 60° and 1400° C., using mesostructured carbonaceous materials with a regular pore size distribution in the range 2 to 50 nm, a specific surface area between 200 and 3000 m2/g and pore volume between 0.5 and 2 cm3/g (Ep: 52 to 81%) as catalysts. The catalytic decomposition can be carried out in a fluidized bed. It is described that the majority of commercial micropores carbonaceous materials undergo progressive deactivation as a result of plugging of their micropores by the generated carbon deposits.

WO 2016/26562 describes the production of syngas, wherein hydrocarbon is thermally decomposed into hydrogen and carbon in a first reaction zone and the produced hydrogen is reacted with carbon dioxide in a second reaction zone to produce carbon monoxide. Both reaction steps are preferably conducted in a moving bed of solid granular material. A carbon-containing granular material may be used being macroporous and having a porosity of preferably 0.25 to 0.6 ml/ml and a mean pore radius of 0.01 to 50 μm. It is mentioned that the carbon-containing granular material may contain 0% to 15 wt.-% of metal, metal oxide and/or ceramic.

US 2020/61565 describes a cyclic process for endothermic reaction, e.g. pyrolysis reactions, containing of three steps (i) a production step, (ii) a purge step and (iii) a regeneration step. The production zone contains a packing of solid particles. Such packing may consist of carbon-containing granular material being macroporous and having a porosity of preferably 0.25 to 0.6 ml/ml and mean pore radius of 0.5 to 5 μm. It is also mentioned that the carbon-containing granular material may contain 0% to 15 wt.-% of metal, metal oxide and/or ceramic. Most of the disclosed experiments on methane decomposition are conducted on a laboratory scale in a batch mode in fixed-bed reactors for a very short period of time. The main problem to cross the gap between the laboratory scale and its industrial implementation is the impact of deposition of coke and other solids on the process in industrial dimension and time scale. Coke generated in the chemical reactor is deposited in the pore system of the carrier, on the geometric surface of the carrier as well as on equipment surfaces. The severe impact of coke deposited on reactor wall surfaces can be seen in industrial thermal cracking reactors: periodic shutdowns for regeneration are needed in order to assure sufficient heat transfer to the reaction medium and to reduce the pressure drop. Also, coke deposited within the pores can be problematic: in catalyzed thermal cracking, it is known to deactivate the catalyst (see Abánades, A., et al. “Experimental analysis of direct thermal methane cracking.” International journal of hydrogen energy 36.20 (2011): 12877-12886 and Geißler, T., A. Abánades, A. Heinzel, K. Mehravaran, G. Müller, R. K. Rathnam, C. Rubbia et al. “Hydrogen production via methane pyrolysis in a liquid metal bubble column reactor with a packed bed.” Chemical Engineering Journal 299 (2016): 192-200). Moreover, coke deposited on the geometric surface of the carriers is an issue in industrial application: it will agglomerate the carrier bed if deposition is maldistributed or too high. In case of batch-wise fixed-bed operation, it will complicate the removal of the fixed-bed. In case of continuous moving-bed operation, it will block the moving-bed and require shutdown of the reactor for removal of the blockage.

In comparison to deposition of coke, the deposition of other solids might even more problematic. Deposited solids like iron, manganese, nickel, cobalt, and others might have catalytic properties facilitating unwanted side reactions leading to a loss in selectivity to the desired products and/or facilitating the formation of soot, which will lead to fouling and block the reactor or other equipment requiring shutdown of the process and removal of soot and regeneration of surfaces due to fouling. For instance, iron as well as cobalt are well known to catalyze chain-growth reactions to hydrocarbons from gas mixtures containing hydrogen and carbon oxides (B. H. Davis, “Fischer-Tropsch Synthesis: Comparison of Performances of Iron and Cobalt Catalysts” Industrial & Engineering Chemistry Research 46 (2007): 8938-8945). Nickel and iron are reported to facilitate carbon filament growth with detrimental effects like mechanical disintegration of granular catalyst particles or blockage of reactors (I. Alstrup, “A new Model Explaining Carbon Filament Growth on Nickel, Iron, and Ni—Cu Alloy Catalysts” Journal of Catalysis 109 (1988): 241-251).

Apart from that, deposition of solids according to a physical vapor deposition (PVD) or chemical vapor deposition (CVD) mechanism leads to accumulation of the deposit at a certain position in the reactor or other equipment. If concentrated to certain position, the impact of the deposit will be even more severe. If this position is for instance in the carrier bed, it will block the bed at this position with the consequences for fixed-bed and moving-bed as given above. If concentrated to a certain position in piping, it might lead to an increase in pressure drop.

To the best of our knowledge, the leaching of inorganic materials, in particular metals and metal oxides, out of the carrier and their deposition at different positions have not been addressed in literature with regard to the process of pyrolysis of natural gas. This might be due to the lack of continuous pyrolysis operation in technical scale by now, where this effect will be more apparent than in short-term lab experiments.

Removing these solid layers and deposits as given above has been a severe problem, which has so far prevented continuous large-scale industrial application of this process.

In addition, in national gas pyrolysis, the formation and deposition of pyrolytic carbon changes the structure of the carrier particles. The pyrolytic carbon fills the macropores and blocks the nano pores of the carrier and also grows shell-like on the outer surface. The blocking of the pores shrinks the effective surface area for the deposition of the pyrolytic carbon. The result is a decrease in the reaction rate and a greater tendency to soot formation. This can result in a significant yield loss of pyrolytic carbon. The greater tendency to soot formation can be explained by the so-called HACA (‘hydrogen abstraction carbon addition”) mechanism for surface carbon growth (F. Xu, P. B. Sunderland, G. M. Faeth, “Soot formation in laminar premixed ethylene/air flames at atmospheric pressure”, Combustion and Flame 108 (1997): 471-493). A precursor species like acetylene reacts with a solid surface adding carbon to the surface and releasing hydrogen to the gas phase. If the surface area is reduced, different routes for the reactions of acetylene or others will become more prominent than the HACA reaction with the solid surface. A known route is the reaction of acetylene leading to the formation of aromatic compounds, which in turn are precursors for soot formation.

In the process for producing hydrogen by pyrolysis of methane and/or light hydrocarbons etc. it is desired to maximize the hydrogen production capacity per reactor volume, i. e. to produce the maximum amount of hydrogen in a reactor of minimum size. Not only the investment cost of the reactor scales with reactor size, also the mechanical design and requirements are eased by smaller reactor sized and heat losses are reduced at smaller reactor sizes. To achieve this target, it is required that the amount of carbon deposition per reactor volume is maximized without affecting the stability and continuity of the production process by the issues associated with deposition of carbon and other solids given above.

Thus, an increase of the carbon deposition per reactor volume shall not lead to blockage of the reactor for the gas stream, the accumulation of soot or any other effects requiring a more frequent shutdown and/or regeneration of the reactor.

### TASK

It is an object of the present invention to minimize the solid deposit in the reactor system, e. g. on the walls. It is a further object of the present invention to minimize the formation of soot. It is a further object of the present invention to minimize the formation of bridging between particular carrier material. Further, it is an object of the invention to maximize the deposition of carbon per reactor volume in order to maximize the hydrogen production capacity per reactor volume.

### INVENTION

The present invention provides a process of producing hydrogen comprising introducing methane and/or other light hydrocarbons into a reaction chamber and reacting/decomposing said gases in said reaction chamber in a bed of solid carbonaceous materials to give hydrogen, wherein said carbonaceous materials are macro-structured carbonaceous materials, wherein the porosity of the carbonaceous material is in the range of 30 to 70 vol.-% and the carbonaceous material contains of a carbon content of 99 wt.-% to 100 wt.-% and a content of alkaline-earth metals, transition metals and metalloids of 0 and 1 wt.-% in relation to the total mass of solid carbonaceous material, wherein the iron content is between 0 and 0.5 wt.-%, the magnesium content is between 0 and 0.005 wt.-%, the manganese content is between 0 and 0.01 wt.-%, the silicon content is between 0 and 0.01 wt.-% and the nickel content is between 0 and 0.025 wt.-%.

In addition, the present invention provides the use of said carbonaceous materials as carrier material in bed reactors e. g. for decomposition reactions like pyrolysis or cracking, especially in moving bed reactors or in fixed-bed reactors conducted in a cyclic operation mode.

Surprisingly, it was found that during pyrolysis conditions alkaline-earth and transition metals inorganic compounds like iron, manganese and magnesium present in the carbonaceous material are resolved from the carbonaceous material, even though the boiling temperatures of the corresponding oxides are >1000° C. higher than temperatures during pyrolysis. The inorganic compounds are deposited further downstream, where lower temperatures prevail. Since the deposition is determined by temperature, the compounds are accumulated at a certain position in the reactor. This will have multiple negative consequences causing issues in industrial scale at long-term or continuous operation: (1) An accumulation of deposited compounds can lead to reduced flowability or even blockage in case of moving-bed operation. Note that this different to the regular deposition of carbon by pyrolysis because the carbon does not accumulate at a certain position in contrast to the deposition of said materials. (2) An accumulation of a catalytically active material like Fe or Ni will locally increase the reaction rates of the pyrolysis reaction leading to a locally increased deposition of carbon, which will facilitate formation of agglomerates or blocking of the bed.

Furthermore, one might expect that sulfur present as side component in the carbonaceous material might be resolved at pyrolysis conditions and carried out in the gas stream in the form of H₂S. Surprisingly, we found, however, that sulfur is not only carried out as H₂S, but sulfur containing deposits are also formed downstream at temperatures lower than 800° C. These deposits will cause issues as well in industrial scale at long-term or continuous operation.

Both these issues can be avoided by application of carbonaceous materials according to this invention, which avoid the formation of said deposits and enable a long-term or even continuous operation in industrial scale.

Furthermore, it was found that pore volume of microporous and mesoporous supports ranging from 0 to 10 nm is not usable for carbon deposition. Uniform and continuous growth both in the particle interior and on the geometric surface can solely be achieved by using macro-structured carbonaceous materials. Thus, higher amounts of carbon deposition can be obtained with macro-structured materials in contrast to activated carbon without negative effects like soot formation or limitation of the pourability of particles during moving-bed or after fixed-bed operation. In addition, activated carbon materials suffer from higher attrition and lower hardness in comparison to the macro-structured carbonaceous materials of this invention.

In addition, carriers with higher BET surface area and accordingly pores within the meso- and micropore size are disadvantageous, since pores are not filled by deposition of carbon and thus exhibit a lower particle density after pyrolysis, are mechanically less stable and show higher attrition.

The use of this carrier material is particularly preferred in a moving bed process. The main advantages of the moving bed are: a continuous operation, heat integration and less tendence for agglomeration of separate particles due to high relative movement.

### Carbonaceous Carrier Material:

### Macro-Structured, Pore Distribution:

The wording “macro-structured” includes material with median pore diameters (i. e. pore diameter at 50% of total pore volume as measured by Hg porosimetry) ranging from 1 to 100 μm, preferably 5 to 100 μm and, more preferably 10 to 80 μm, in particular 15 to 60 μm.

### Porosity:

Preferably the porosity of the carbonaceous material is in the range of 30 to 70 vol.-%, more preferably 40 to 60 vol.-%. Preferably, the pore volume is in the range of 0.2 to 1.1 ml/g, more preferably 0.3 to 0.7 ml/g.

### BET:

The BET surface area is preferably between 0.1 and 100 m2/g, preferably 0.1 and 50 m2/g, in particular 0.1 to 30 m2/g.

### Density:

Preferably, the density of the carbonaceous material is in the range of 1.5 to 2.5 g/cc, preferably 1.6 to 2.3 g/cc, more preferably 1.8 to 2.2 g/cc, even more preferably 1.9 to 2.15 g/cc (real density in xylene, ISO 8004). Preferably, the bulk density of the carbonaceous material is in the range of 0.5 to 1.5 g/cc, preferably 0.6 to 1.3 g/cc, more preferably 0.7 to 1.1 g/cc.

### Size:

The particle size distribution of the carbonaceous material has a D10 in the range of 1 to 5 mm, preferably 2 to 5 mm and more preferably 3 to 5 mm. The D90 is preferably 2 to 15 mm, preferably 3 to 12 mm and more preferably 4 to 9 mm.

The fraction of particle size under 0.1 mm, preferably under 10 μm, more preferably under 5 μm being at most 20 ppm by weight, more preferably being at most 10 ppm by weight. The fraction of particle size under 0.1 mm, preferably under 10 μm, more preferably under 5 μm being in the range of 0 to 20 ppm by weight, preferably 0 to 10 ppm by weight.

### Shape/Uniformity

The granule particles have a regular and/or irregular geometric shape. Regular-shaped particles are advantageously spherical, cylindrical or of any other shape with aspect ratios of 1 to 5, preferably 1 to 4 and more preferably 1 to 3.

### Composition:

The carbonaceous material in the present invention is understood to mean a material that advantageously contains of at least 99%, further preferably at least 99.5%, especially at least 99.75% by weight of carbon. Preferably the carbonaceous material contains of a carbon content of 99 wt.-% to 100 wt.-%, and more preferably 99.5 wt.-% to 100 wt.-%.

The oxygen content of the carbonaceous material is preferably lower than 0.5 wt.-%, preferably lower than 0.05 wt.-% and more preferably below 0.005 wt.-%. The oxygen content of the carbonaceous material is preferably between 0 and 0.5 wt.-%, preferably between 0 and 0.05 wt.-% and more preferably between 0 and 0.005 wt.-%. Oxygen in the carbonaceous material carrier accelerates the reaction of the gaseous hydrocarbon and leads to locally concentrated deposition of carbon, which forms agglomerates and blocks the carrier bed.

The content of alkaline-earth metals, transition metals and metalloids of the carbonaceous material is preferably between 0 and 1 wt.-%, preferably between 0 and 0.75 wt.-% and more preferably between 0 and 0.5 wt.-% based on the total mass of the carbonaceous material.

The alkaline-earth metals, transition metals and metalloids can be present in all possible oxidation state, for example in elemental form, as oxides, sulfides halides, sulfates, carbonates etc.

The iron content of the carbonaceous material is preferably between 0 and 0.5 wt.-%, preferably between 0 and 0.1 wt.-%, more preferably between 0 and 0.05 wt.-%, and more preferably between 0 and 0.01 wt.-%.

The magnesium content of the carbonaceous material is preferably between 0 and 0.005 wt.-%, preferably between 0 and 0.0025 wt.-% and more preferably between 0 and 0.001 wt.-%.

The manganese content of the carbonaceous material is preferably between 0 and 0.01 wt.-%, preferably between 0 and 0.005 wt.-% and more preferably between 0 and 0.001 wt.-%.

The nickel content of the carbonaceous material is preferably between 0 and 0.025 wt.-%, preferably between 0 and 0.01 wt.-%, and more preferably between 0 and 0.001 wt.-% (The nickel content of the carbonaceous material is preferably between 0 and 250 ppm, preferably between 0 and 100 ppm and more preferably between 0 and 10 ppm).

The silicon content of the carbonaceous material is preferably lower than 1 wt.-%, preferably lower than 0.1 wt.-% and more preferably lower than 0.01 wt.-%. The silicon content of the carbonaceous material is preferably between 0 and 0.01 wt.-%, preferably between 0 and 0.005 wt.-% and more preferably between 0 and 0.001 wt.-%.

The sulfur content of the carbonaceous material is preferably lower than 1 wt.-%, preferably lower than 0.5 wt.-% and more preferably lower than 0.3 wt.-%, even more preferably lower than 0.1 wt.-%. The sulfur content of the carbonaceous material is preferably between 0 and 1.0 wt.-%, preferably between 0 and 0.5 wt.-%, more preferably between 0 and 0.3 wt.-% and even more preferably between 0 and 0.1 wt.-%.

At pyrolysis reaction conditions, said metals are resolved from the carbonaceous material and deposited at colder spots in the bed or reactor leading to fouling or blocking of the bed with the need of periodic shutdown of the reactor for cleaning or regeneration. In additions, they might have catalytic properties leading to a decrease in selectivity and/or an increased tendency to soot formation.

### Attrition

The weight loss due to attrition as measured with an air jet sieve with mesh size of 500 μm and air velocities of 35 m/s is preferably between 0 and 10 wt.-%, preferably between 0 and 5 wt.-% and more preferably between 0 and 1 wt.-% based on the total mass of the carbonaceous material after 6 hours.

### Hardness

The hardness of the carbonaceous material as measured by nanoindentation (ISO 14577, Berkovich tip, Load 1 mN) is preferably between 1000 and 15000 MPa, preferably between 1500 and 10000 MPa and more preferably between 2000 and 9000 MPa.

The carbonaceous material is advantageously thermally stable up to 2000° C., preferably up to 1800° C. The carbonaceous material is advantageously thermally stable within the range from 500 to 2000° C., preferably 1000 to 1800° C., further preferably 1300 to 1800° C., more preferably 1500 to 1800° C., especially 1600 to 1800° C.

The carbonaceous material is advantageously electrically conductive within the range between 10 S/cm and 10⁵ S/cm.

### Effective Loading:

The mentioned carbonaceous material carriers are able to take a significant amount of carbon deposits. The mass of the carbonaceous material used can advantageously be increased by the process according to the invention by 10 to 500 wt.-%, based on the original total mass of the carbonaceous material, preferably by 20 to 200 wt.-%, more preferably by 30 to 150 wt.-%.

### Reaction and Moving Bed Conditions:

The bed of carbonaceous materials may favorable be homogeneous or structured over its height. A homogeneous bed may advantageously be a fixed bed, a descending moving bed or a fluidized bed. Especially the bed is guided through said reaction chamber as a (descending) moving bed or one or more fixed beds are used in a cyclical operation mode including a production and a regeneration mode (see for the cyclical operation mode for example WO 2018/83002).

The carbonaceous material is preferably guided in the form of a moving bed through the reaction chamber, with methane and/or other light hydrocarbons being passed advantageously in countercurrent to the carbonaceous material.

For this purpose, the reaction chamber is preferably rationally designed as a vertical shaft, which means that the movement of the moving bed comes preferably about solely under the action of gravity. Flow through the moving bed is able to take place, advantageously, homogeneously and uniformly (see for example WO 2013/004398, WO 2019/145279 and WO 2020/200522).

Energy is advantageously introduced into the high-temperature zone, preferably via electric energy, in particular via joule heating, more preferably via direct electric heating of the carbonaceous material by Joule heating. There is no intention, however, to rule out the generation and/or introduction of thermal energy at other locations in the reaction chamber or by other means.

### Flow Velocity of the Carrier:

The flow velocity of the gas flow is advantageously less than 10 m/s, preferably less than 5 m/s, in particular less than 1 m/s. Preferably, the flow velocity is in the range of 0.2 to 3 m/s, more preferably in the range of 0.5 to 1.5 m/s.

The flow velocity of the carbonaceous materials is advantageously less than 2 cm/s, preferably less than 0.5 cm/s, in particular less than 0.25 cm/s. Preferably, the flow velocity is in the range of 0.005 to 0.5 cm/s, more preferably in the range of 0.01 to 0.25 cm/s.

The throughput of the granular material through the reaction section is advantageously 500 kg/h to 80000 kg/h, preferably from 1000 kg/h to 65000 kg/h, more preferably 1500 kg/h to 50000 kg/h.

The hydrogen volume flow (STP) is advantageously 1000 m3/h to 85000 m3/h, preferably 2000 m3/h to 60000 m3/h, more preferably 3000 m3/h to 50000 m3/h.

The mass flow ratio between the hydrocarbon gas and the carbonaceous pellets is advantageously between 1.5 and 3, preferably between 1.8 and 2.5.

The ratio of the heat capacities of the descending granular flow to the ascending gas flow in the reaction section is advantageously 0.1 to 10, preferably 0.5 to 2, more preferably 0.75 to 1.5, most preferably 0.85 to 1.2. This ensures the preconditions of an efficient heat integrated operation of the reactor. The effectiveness factor of internal heat recovery is advantageously 50% to 99.5%, preferably 60% to 99%, more preferably 65% to 98%.

The gas residence time in the reaction zone under standard conditions in the inventive decomposition reaction is advantageously between 0.5 and 20 s, preferably between 1 and 10 s. The residence time of the carbonaceous material is preferably between 0.5 and 15 hours, preferably between 1 and 10 hours and more preferably between 2 and 8 hours.

The residence time of the carbonaceous material per gas residence time under standard conditions is advantageously in the range from 200 to 5000, preferably in the range from 300 to 3000, in particular from 400 to 2000.

The inventive thermal decomposition reaction of hydrocarbons is advantageously performed at a mean temperature in the reaction zone of 800 to 1600° C., preferably between 110° and 1400° C.

The inventive thermal decomposition reaction of methane and/or other higher hydrocarbons is advantageously performed at atmospheric pressure up to a pressure of 50 bar, preferably at atmospheric pressure to 30 bar, in particular at atmospheric pressure up to 20 bar.

The volume of the reaction section is preferably 1 m3 to 1000 m3, preferably 5 m3 to 750 m3, more preferably 0.5 m3 to 500 m3. The height of the reaction section is preferably 0.1 m to 50 m, preferably 0.5 to 20 m, more preferably 1 m to 10 m.

Optionally, this section comprises build-ins, e. g. electrodes for conducting electrical current to the packing of the moving bed for supplying joule heating to the process.

### Preferred Reactions:

The inventive process is advantageously used for pyrolysis reaction, for steam reforming, dry reforming or combinations thereof. The adaption in view of gas flows, flow of the carbonaceous material and heating power can easily be done by a person skilled in the art.

In case of pyrolysis reaction, methane and/or other light hydrocarbons decompose in said reaction chamber in a bed of carbonaceous materials to give hydrogen and solid carbon.

In case of steam reforming, methane and/or other light hydrocarbons react with water in said reaction chamber in a bed of carbonaceous materials to give hydrogen, carbon monoxide and carbon dioxide.

In case of dry reforming, methane and/or other light hydrocarbons react with carbon dioxide in said reaction chamber in a bed of carbonaceous materials to give hydrogen, carbon monoxide and water.

In case of a combination of pyrolysis with steam reforming, methane and/or other light hydrocarbons react with water in said reaction chamber in a bed of carbonaceous materials to give hydrogen, solid carbon, carbon monoxide and carbon dioxide.

In case of a combination of pyrolysis with dry reforming, methane and/or other light hydrocarbons react with carbon dioxide in said reaction chamber in a bed of carbonaceous materials to give hydrogen, solid carbon, carbon monoxide and water.

In case of a combination of pyrolysis with dry reforming and steam reforming, methane and/or other light hydrocarbons react with carbon dioxide and water in said reaction chamber in a bed of carbonaceous materials to give hydrogen, solid carbon and carbon monoxide.

### EXAMPLES

### 1. Influence of Inorganic Compounds

### Example 1

Methane pyrolysis was performed in a laboratory-scale fixed-bed reactor setup with inner tube diameter of 50 mm and a length of the fixed-bed of 0.5 m. In the center of the fixed-bed, another tube with outer diameter of 10 mm is positioned, which is equipped for measurement of temperature. For pyrolysis, the reactor tube was heated externally to 1450° C. The carbonaceous material had a pore volume of 0.2 ml/g and a median pore diameter of 16 μm. The contents of iron, magnesium, manganese, nickel and silicon were 0.008 wt.-%, <0.001 wt.-%, <0.001 wt.-%, 0.002 wt.-% and 0.002 wt.-%, respectively.

Pyrolysis was performed for 170 minutes at a volume flow of methane of 60 Nl/h. A methane conversion of 98% was obtained. The pressure drop over the fixed-bed remained constant. The pressure drop over a filter placed in the effluent stream of the reactor was also constant throughout the pyrolysis duration. Thus, no indication for soot formation was observed. After pyrolysis and cooling down, the reactor was opened, and the carbonaceous material was removed. No inorganic deposits were found on the surfaces of the reactor.

### Example 2

Methane pyrolysis was performed in the same setup and at the same conditions as in Example 1. The carbonaceous material had a pore volume of 0.2 ml/g and a median pore diameter of 14 μm. The contents of iron, magnesium, manganese, nickel and silicon were 0.034 wt.-%, 0.002 wt.-%, <0.001 wt.-%, 0.024 wt.-% and 0.012 wt.-%, respectively.

Pyrolysis was performed for 170 minutes at a volume flow of methane of 60 Nl/h. A methane conversion of 99% was obtained. The pressure drop over the fixed-bed remained constant. The pressure drop over a filter placed in the effluent stream of the reactor was also constant throughout the pyrolysis duration. Thus, no indication for soot formation was observed. After pyrolysis and cooling down, the reactor was opened, and the carbonaceous material was removed. No inorganic deposits were found on the surfaces of the reactor.

### Comparative Example 1

Methane pyrolysis was performed in the same setup and at the same conditions as in Example 1. The carbonaceous material had a pore volume of 0.2 ml/g and a median pore diameter of 23 μm. The contents of iron, magnesium, manganese, nickel and silicon were 1.0 wt.-%, 0.006 wt.-%, 0.02 wt.-%, 0.002 wt.-% and 0.11 wt.-% respectively.

A methane conversion of 98% was obtained. The pressure drop over the fixed-bed remained constant. The pressure drop over a filter placed in the effluent stream of the reactor was also constant throughout the pyrolysis duration. Thus, no indication for soot formation was observed. After pyrolysis and cooling down, the reactor was opened, and the carbonaceous material was removed. Inorganic deposits were found: Surfaces of the reactor were covered by a thin film (<1 mm) of deposited material. On the surface of the central tube in the reactor also flakes of material (maximum size 10 mm×5 mm×5 mm) adhering to the surfaces were found. The surface composition of certain spots (see FIG. 6) on these flakes was analyzed by Scanning electron microscopy with energy-dispersive X-ray spectroscopy (SEM-EDX). The surface composition at six spots is listed in Table 1.

TABLE 1
SEM-EDX results of deposits (wt.-%) in
Comparative Example 1 at different spots.

| Position | Carbon | Oxygen | Magnesium | Manganese |
|---|---|---|---|---|
| 1 | 25.2 | 37.2 | 27.4 | 5.4 |
| 2 | 61.1 | 22.2 | 10.8 | 4.1 |
| 3 | 21.5 | 29.0 | 24.0 | 16.4 |
| 4 | 26.7 | 32.0 | 24.2 | 8.9 |
| 5 | 13.1 | 34.1 | 34.3 | 11.4 |
| 6 | 15.2 | 22.0 | 28.5 | 24.7 |

Thus, Mg and Mn were resolved from the carbonaceous material and deposited. Deposited material was also scratched from the reactor surfaces (i.e. central tube and outer tube) and analyzed by Atomic absorption spectroscopy (AAS). The deposits contained 4.7 wt.-% iron. That inorganic compounds that are resolved from the carbonaceous materials can also be seen from elementary analytics by AAS of the carbonaceous material after pyrolysis. In the carbonaceous material placed in the inlet region of the reactor, the contents of iron, magnesium, manganese, nickel and silicon were reduced to 0.88 wt.-%, <0.001 wt.-%, <0.001 wt.-%, 0.001 wt.-% and 0.026 wt.-%, respectively.

Inorganic deposits on surfaces were also visible after regeneration of the reactor internals by oxidizing in air. FIG. 2 shows the picture of the central tube in fresh state and after regeneration by air. Brownish deposits are clearly visible.

### Comparative Example 2

Methane pyrolysis was performed in the same setup and at the same conditions as in Example 1. The carbonaceous material had a pore volume of 0.1 ml/g and a median pore diameter of 15 μm. The contents of iron, magnesium, manganese, nickel and silicon were 0.023 wt.-%, 0.003 wt.-%, 0.002 wt.-%, 0.042 wt.-% and 0.015 wt.-% respectively.

A methane conversion of 98% was obtained. The pressure drop over the fixed-bed remained constant. The pressure drop over a filter placed in the effluent stream of the reactor was also constant throughout the pyrolysis duration. Thus, no indication for soot formation was observed. After pyrolysis and cooling down, the reactor was opened, and the carbonaceous material was removed. No inorganic deposits were found on the surfaces of the reactor.

The elemental composition of the carbonaceous material located at the very top of the fixed-bed, where temperatures <1000° C. prevail, was analyzed by AAS. Nickel and silicon were analyzed as 0.053 wt.-% and 0.042 wt.-% and were thus accumulated at this position of the fixed-bed.

2. Influence of the structure of the carbonaceous material

### Example 3

Methane pyrolysis was performed in the same setup as in Example 1. The reactor tube was heated externally to 1200° C. The carbonaceous material had a pore volume 0.2 ml/g of and a median pore diameter of 20 μm.

Pyrolysis was performed for 90 minutes at a volume flow of methane of 120 Nl/h. A methane conversion of 83% was obtained. The pressure drop over the fixed-bed remained constant. The pressure drop over a filter placed in the effluent stream of the reactor was also constant throughout the pyrolysis duration. Thus, no indication for soot formation was observed.

### Comparative Example 3

Methane pyrolysis was performed in the same setup and at the same conditions as in Example 2. As material for the fixed-bed non-porous corundum particles were used.

The pyrolysis had to be stopped after 75 minutes due to the increased pressure drop: the pressure was constant for 65 minutes and started then to increase from 52 mbar to 77 mbar within 10 minutes. A methane conversion of 77% was obtained

The evolvement of the pressure drop in Example 3 and Comparative example 3 is compared in FIG. 3.

### 3. Influence of Pore Volume Fraction:

### Example 4

Methane pyrolysis was performed in the same setup as in Example 1. The reactor tube was heated externally to 1200° C. The carbonaceous material had a pore volume 0.2 ml/g of and a median pore diameter of 20 μm. Pyrolysis was performed for 60 minutes at a volume flow of methane of 180 Nl/h. A methane conversion of 81% was obtained.

After pyrolysis, the reactor was cooled down. The fixed-bed of carbonaceous material was removed in six portions, whose filling density was determined and which were analyzed qualitatively in terms of agglomeration. Hereby, the following levels of agglomeration were discriminated: (1) loose, (2) gently, (3) markedly, (4) firmly. The results are given in FIG. 5.

### Example 5

Methane pyrolysis was performed in the same setup as in Example 1 applying the same carbonaceous material and conditions as in Example 3. Pyrolysis was performed for 75 minutes. A methane conversion of 81% was obtained. The fixed-bed was analyzed as in Example 3. The results are given in FIG. 5

### Example 6

Methane pyrolysis was performed in the same setup as in Example 1 applying the same carbonaceous material and conditions as in Example 3. Pyrolysis was performed for 45 minutes. A methane conversion of 81% was obtained. The fixed-bed was analyzed as in Example 3. The results are given in FIG. 5.

### Comparative Example 4

Methane pyrolysis was performed in the same setup as in Example 1. The reactor tube was heated externally to 1200° C. The carbonaceous material had a pore volume 0.1 ml/g of and a median pore diameter of 29 μm. Pyrolysis was performed for 60 minutes at a volume flow of methane of 180 Nl/h. A methane conversion of 77% was obtained. The fixed-bed was analyzed as in Example 3. The results are given in FIG. 5.

### Comparative Example 5

Methane pyrolysis was performed in the same setup as in Example 1 applying the same carbonaceous material and conditions as in Comparative Example 3. Pyrolysis was performed for 45 minutes. A methane conversion of 77% was obtained. The fixed-bed was analyzed as in Example 3. The results are given in FIG. 5.

### Comparative Example 6

Methane pyrolysis was performed in the same setup as in Example 1 applying the same carbonaceous material and conditions as in Comparative Example 3. Pyrolysis was performed for 30 minutes. A methane conversion of 77% was obtained. The fixed-bed was analyzed as in Example 3. The results are given in FIG. 5.

### Comparative Example 7

Methane pyrolysis was performed in the same setup as in Example 1 applying the same carbonaceous material and conditions as in Comparative Example 3. Pyrolysis was performed for 20 minutes. A methane conversion of 78% was obtained. The fixed-bed was analyzed as in Example 3. The results are given in FIG. 5.

According to the summary of results in FIG. 5 the carbonaceous material with the pore volume of 0.2 ml/g (Examples 4-6) allows carbon depositions of up to 10 wt % with the degree of agglomeration being loose or gentle. In contrast, the agglomeration was rated as markedly in case of the less porous material (Comparative Examples 4-7) already at depositions <10 wt %. For the carbonaceous material with the pore volume of 0.2 ml/g, only two out of seven samples with the deposition >10 wt % were rated as markedly. For the carbonaceous material with the pore volume of 0.1 ml/g four out of six samples with the deposition >5 wt % were rated as markedly. Accordingly, carbonaceous material according to this invention is beneficial for avoiding formation of agglomerates.

### Summary

| | | median | | | | | | |
|---|---|---|---|---|---|---|---|---|
| | pore | pore | | | | | | |
| | volume | diameter | Composition [wt.-%] | | | | | |
| | [ml/g] | [μm] | Fe | Mg | Mn | Ni | Si | result |
| Example 1 | 0.2 | 16 | 0.008 | <0.001 | <0.001 | 0.002 | 0.002 | No |
| | | | | | | | | deposition of |
| | | | | | | | | solids |
| | | | | | | | | observed |
| Example 2 | 0.2 | 14 | 0.034 | 0.002 | <0.001 | 0.024 | 0.012 | No |
| | | | | | | | | deposition of |
| | | | | | | | | solids |
| | | | | | | | | observed |
| Comparative | 0.2 | 23 | 1.0 | 0.006 | 0.02 | 0.002 | 0.11 | Deposition of |
| Example 1 | | | | | | | | inorganic |
| | | | | | | | | solids |
| | | | | | | | | containing |
| | | | | | | | | Fe, Mg, Mn. |
| | | | | | | | | Depletion of |
| | | | | | | | | Si in fixed- |
| | | | | | | | | bed |
| Comparative | 0.1 | 15 | 0.023 | 0.003 | 0.002 | 0.042 | 0.015 | Accumulation |
| Example 2 | | | | | | | | of Ni and Si |
| | | | | | | | | measured in |
| | | | | | | | | upper region |
| | | | | | | | | of fixed-bed |
| Example 3 | 0.2 | 20 | 0.006 | 0.003 | <0.001 | 0.010 | 0.004 | Constant |
| | | | | | | | | pressure |
| | | | | | | | | drop |
| | | | | | | | | throughout |
| | | | | | | | | experiment |
| Comparative | 0 | — | <0.001 | 0.002 | <0.001 | <0.001 | 0.002 | Increase of |
| Example 3 | | | | | | | | pressure |
| | | | | | | | | drop |
| Example 4 | 0.2 | 20 | 0.006 | 0.003 | <0.001 | 0.010 | 0.004 | Lower |
| Example 5 | 0.2 | 20 | 0.006 | 0.003 | <0.001 | 0.010 | 0.004 | tendency to |
| Example 6 | 0.2 | 20 | 0.006 | 0.003 | <0.001 | 0.010 | 0.004 | form |
| | | | | | | | | agglomerates |
| | | | | | | | | than in |
| | | | | | | | | Comparative |
| | | | | | | | | Examples 4- |
| | | | | | | | | 7 |
| Comparative | 0.1 | 29 | 0.001 | <0.001 | <0.001 | <0.001 | n.m. | Higher |
| Example 4 | | | | | | | | tendency to |
| Comparative | 0.1 | 29 | 0.001 | <0.001 | <0.001 | <0.001 | n.m. | form |
| Example 5 | | | | | | | | agglomerates |
| Comparative | 0.1 | 29 | 0.001 | <0.001 | <0.001 | <0.001 | n.m. | than in |
| Example 6 | | | | | | | | Examples 4- |
| Comparative | 0.1 | 29 | 0.001 | <0.001 | <0.001 | <0.001 | n.m. | 6 |
| Example 7 | | | | | | | | |

### DESCRIPTION OF THE FIGURES

FIG. 1: Princip of a process of production hydrogen via an electric heated bed reactor

FIG. 2: Photograph of fresh central tube (top) and after regeneration after Comparative Example 2 (bottom).

FIG. 3: Evolvement of the pressure drop in Example 3 and Comparative example 3

FIG. 4: Carrier according to example 1 (a) Cumulative pore volume distribution (b) Particle Size Distribution (c) Photograph of the carrier

FIG. 5: Degree of agglomeration

FIG. 6: Locations of SEM-EDX measurements of Table 1

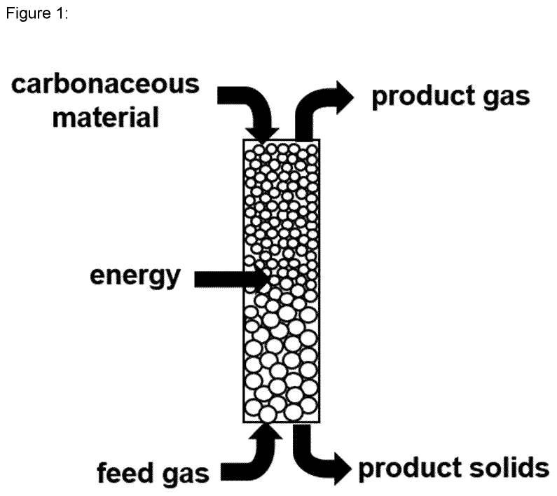

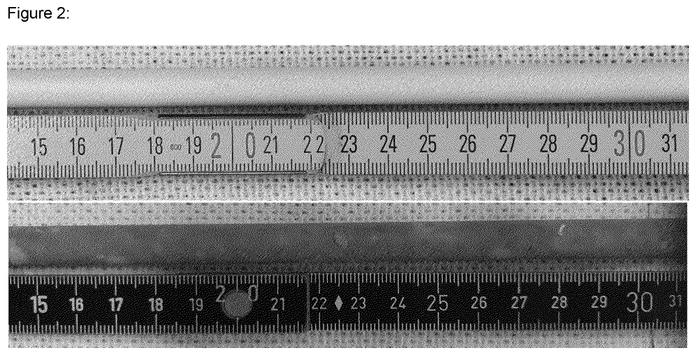

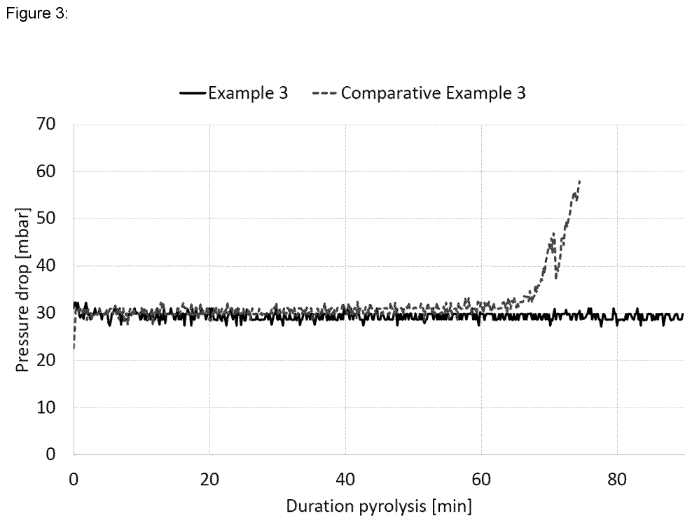

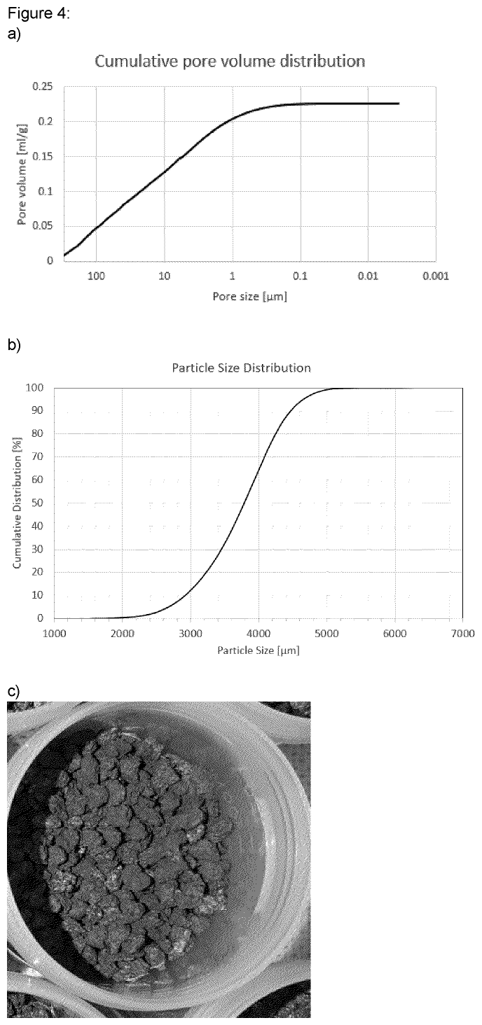

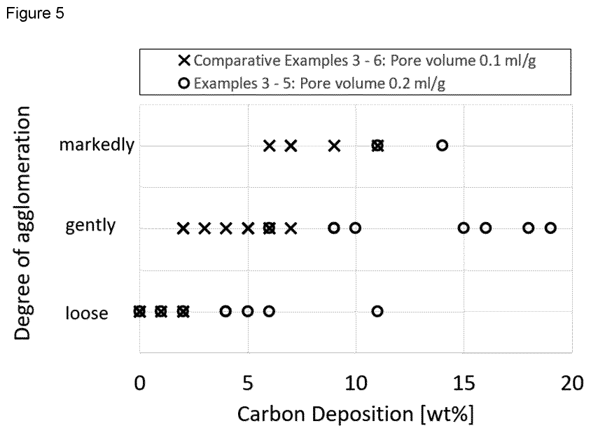

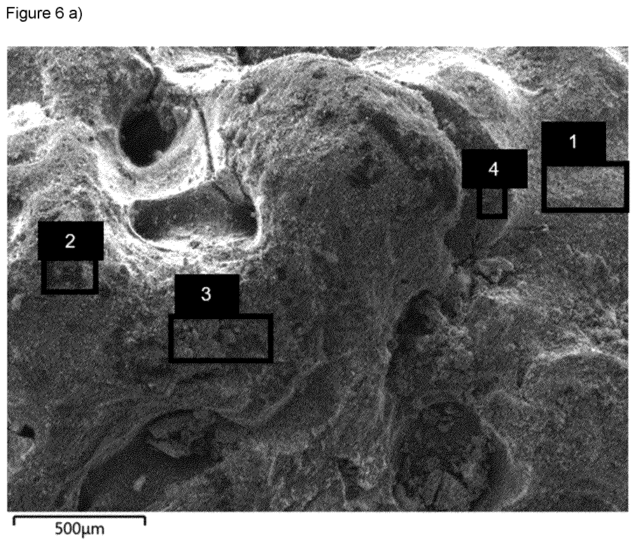

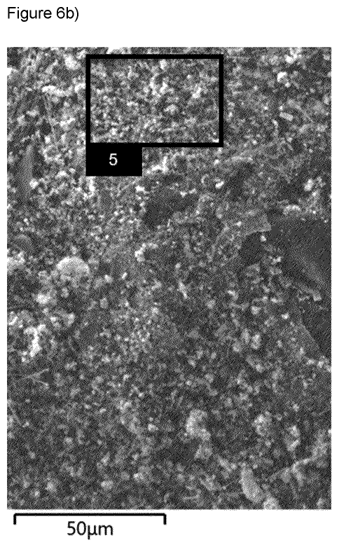

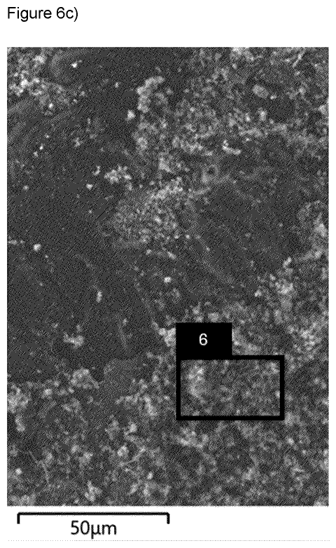

1.-15. (canceled)

16. A process of producing hydrogen comprising introducing methane and/or other light hydrocarbons into a reaction chamber and reacting said gases in said reaction chamber in a bed of solid carbonaceous materials to give hydrogen, wherein said carbonaceous materials are macro-structured carbonaceous materials, wherein the porosity of the carbonaceous material is in the range of 30 to 70 vol.-% and the carbonaceous material contains a content of carbon of 99 wt.-% to 100 wt.-% and a content of alkaline-earth metals, transition metals and metalloids of 0 and 1 wt.-% in relation to the total mass of said solid carbonaceous material, wherein the iron content is between 0 and 0.5 wt.-%, the magnesium content is between 0 and 0.005 wt.-%, the manganese content is between 0 and 0.01 wt.-%, the silicon content is between 0 and 0.01 wt.-% and the nickel content is between 0 and 0.025 wt.-%.

17. The process according to claim 16, wherein the median pore diameter of the macro-structured carbonaceous material is ranging from 10 to 80 μm.

18. The process according to claim 16, wherein the iron content of the carbonaceous material is between 0 and 0.1 wt.-% in relation to the total mass of said solid carbonaceous material.

19. The process according to claim 16, wherein the magnesium content of the carbonaceous material is between 0 and 0.001 wt.-% in relation to the total mass of said solid carbonaceous material.

20. The process according to claim 16, wherein the manganese content is between 0 and 0.001 wt.-% in relation to the total mass of said solid carbonaceous material.

21. The process according to claim 16, wherein the nickel content of the carbonaceous material is between 0 and 0.01 wt.-% in relation to the total mass of said solid carbonaceous material.

22. The process according to claim 16, wherein the sulfur content of the carbonaceous material is between 0 and 1.5 wt.-% in relation to the total mass of said solid carbonaceous material.

23. The process according to claim 16, wherein the silicon content of the carbonaceous material is between 0 and 0.005 wt.-% in relation to the total mass of said solid carbonaceous material.

24. The process according to claim 16, wherein the BET surface area of the carbonaceous material is between 0.1 and 100 m2/g.

25. The process according to claim 16, wherein the particle size of the carbonaceous material is between 1 to 5 mm (d10) to 2 to 15 mm (d90).

26. The process according to claim 16, wherein carbonaceous material contains 99.5 to 100 wt.-% of carbon.

27. The process according to claim 16, wherein the carbonaceous material contains 0 to 0.5 wt.-% of oxygen.

28. The process according to claim 16, wherein the hardness of the carbonaceous materials as measured by nanoindentation is between 1 and 10 GPa.

29. The process according to claim 16, wherein hydrogen is produced by pyrolysis reaction, by steam reforming, by dry reforming or combinations thereof.

30. A method for operating a bed reactor comprising utilizing macro-structured carbonaceous materials as carrier material, wherein the porosity of the carbonaceous material is in the range of 30 to 70 vol.-%, the carbonaceous material contains a content of carbon of 99 wt.-% to 100 wt.-% and a content of alkaline-earth metals, transition metals and metalloids of 0 to 1 wt.-% in relation to the total mass of said solid carbonaceous material, wherein the iron content is between 0 and 0.5 wt.-%, the magnesium content is between 0 and 0.005 wt.-%, the manganese content is between 0 and 0.01 wt.-%, the silicon content is between 0 and 0.01 wt.-% and the nickel content is between 0 and 0.025 wt.-%.
